(19) United States
(12) Patent Application Publication
(10) Pub. No.: US 2026/0154187 A1
(43) Pub. Date: Jun. 4, 2026

(54) APPLICATION TESTING SANDBOX ENVIRONMENT

(71) Applicant: UPTODATE, INC., Waltham, MA (US)

(72) Inventors: Vishwasrao Salunkhe, Acton, MA (US); Barbara Atkins, Arlington, MA (US); Kannan Ramakrishnan, Naperville, IL (US); Anna Grishkan, Acton, MA (US); David Winters, Jamestown, NY (US)

(21) Appl. No.: 19/406,101

(22) Filed: Dec. 2, 2025

Related U.S. Application Data
(60) Provisional application No. 63/726,948, filed on Dec. 2, 2024.

(51) Int. Cl. G06F 11/3668; H04L 9/32

(52) U.S. Cl. CPC G06F 11/3688; G06F 11/3696; H04L 9/3213

(57) ABSTRACT

A testing environment that simulates the stringent authentication process, and/or processes required for real world use of health care applications that deal with confidential patient information is disclosed. The testing sandbox environment may include a SMART on FHIR application, a FHIR server, a backend service including one or more processing devices, an identity management service, a dynamic database, and/or one or more user computing devices operatively coupled over a network.

### TECHNICAL FIELD

This application relates generally to software application testing, and more particularly, to testing software applications that require user authentication and authorization for access to confidential information.

### BACKGROUND

Developing clinical applications is complex and requires rigorous testing to ensure functionality, performance, and clinical accuracy. The application's success and the company's reputation depend on robust testing processes. Traditional methods often fail to replicate real-world clinical scenarios, making it challenging to validate the application's behavior under varying conditions.

It would be advantageous to have a testing environment that simulates the stringent authentication process, and/or processes required for real world use of health care applications that deal with confidential patient information.

### SUMMARY

In some embodiments, a system for testing a software application for health care that requires fast healthcare interoperability resource (“FHIR”) data is disclosed. The system includes a non-transitory memory and a processor communicatively coupled to the non-transitory memory, wherein the processor is configured to read a set of instructions. The instructions may be performed in a testing environment. The instructions may include instructions to launch the software application at a FHIR Sandbox user interface (“UI”), transmit application data and a launch URL from the FHIR Sandbox UI to SMART on FHIR application (“SoF App”), and transmit launch context data from the FHIR Sandbox UI to a backend service, where the launch context data includes user identifying data. The instructions may include instructions to, in response to receiving the launch context data, transmit a request to validate an access token from the backend service to an identity management service, the access token relating to access to the software application by the user identified in the user identifying data. The instructions may include instructions to, at the identity management service, determine whether the access token is valid.

Upon a determination that the access token is valid, the instructions may include instructions to send confirmation that the access token is valid, from the identity management service to the backend service. The instructions may include instructions to retrieve a user identifier from the access token, transmit the launch context data from the backend service to a dynamic database, and transmit a command from the backend service to a FHIR server, to call a metadata endpoint, causing a capability statement object to be transmitted from the FHIR server to the backend service. The instructions may include instructions to, at the backend service, add an authorization token to the capability statement. The instructions may include instructions to transmit the capability statement, containing the authorization token, from the backend service to the SoF App, and request user consent via the FHIR Sandbox UI. The instructions may include instructions to, using the authorization token received as part of the capability statement, transmit an authorization message from the SoF App to the identity management service. The instructions may include instructions to, in response to receiving the authorization message, transmit an authorization code from the identity management service to the backend service.

The instructions may include instructions to transmit the token endpoint data from the backend service to the identity management service, transmit the access token and an identification token from the identity management service to the backend service, retrieve the user identifier from the access token, request the launch context data from the dynamic database, receive the launch context data at the backend service, add custom claims to the launch context data, send the access token from the backend service to the SoF App, transmit a request for the FHIR data from the SoF App to the backend service, transmit the request for FHIR data from the backend service to the FHIR server, receive the FHIR data at the backend service, forward the FHIR data from the backend service to the SoF App, and use the FHIR data in the software application in the testing environment.

In some embodiments, the launch context data may include at least one of a patient identifier, a practitioner identifier and an encounter identifier. In some embodiments, the user identifier identifies a practitioner user of the software application. In some embodiments, the patient identifier and the encounter identifier relate to an encounter between the practitioner user and a patient. In some embodiments, the FHIR data include confidential health information relating to the patient.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates an application testing sandbox environment configured to provide an application testing sandbox environment, in accordance with some embodiments.

FIG. 2 illustrates a computer system configured to implement one or more processes, in accordance with some embodiments.

FIG. 3 is a data flow diagram of a system for an application testing sandbox environment, in accordance with one embodiment.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

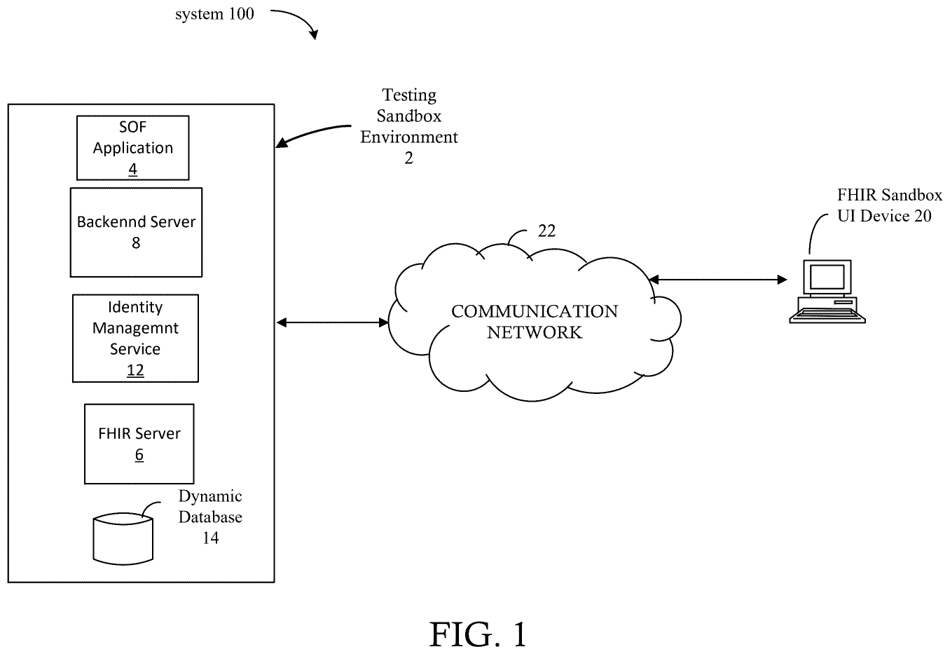

FIG. 1 illustrates a system 100 including a testing sandbox environment 2 configured to provide an application testing sandbox environment, in accordance with some embodiments. The testing sandbox environment 2 includes a plurality of devices or systems configured to communicate over one or more network channels, illustrated as a network cloud 22. For example, in various embodiments, the testing sandbox environment 2 may include, but is not limited to, a SMART on FHIR application (“SoF App”). 4, a FHIR server 6, a backend service 8 including one or more processing devices, an identity management service 12, a dynamic database 14, and/or one or more FHIR sandbox UI devices 20 operatively coupled over the network 22. SoF uses a Substitutable Medical Applications Reusable Technologies (“SMART”) standard, as well as the FHIR standard as discussed above. The SoF App 4, the FHIR server 6, the processing device(s), and/or the FHIR sandbox UI devices 20 may each be a suitable computing device that includes any hardware or hardware and software combination for processing and handling information. For example, each computing device may include, but is not limited to, one or more processors, one or more field-programmable gate arrays (FPGAs), one or more application-specific integrated circuits (ASICs), one or more state machines, digital circuitry, and/or any other suitable circuitry. In addition, each computing device may transmit and receive data over the communication network 22.

In some embodiments, each of the SoF App 4 and the processing device(s) may be a computer, a workstation, a laptop, a server such as a cloud-based server, or any other suitable device. In some embodiments, each of the processing devices is a server that includes one or more processing units, such as one or more graphical processing units (GPUs), one or more central processing units (CPUs), and/or one or more processing cores. Each processing device may, in some embodiments, execute one or more virtual machines. In some embodiments, processing resources (e.g., capabilities) of the one or more processing devices are offered as a cloud-based service (e.g., cloud computing). For example, the backend service 8 may offer computing and storage resources of one or more processing devices.

In some embodiments, FHIR sandbox UI device 20 may be a cellular phone, a smart phone, a tablet, a personal assistant device, a voice assistant device, a digital assistant, a laptop, a computer, or any other suitable device. In some embodiments, the SoF App 4, the processing devices, and/or the FHIR server 6 are operated by the network environment provider, and the FHIR sandbox UI device 20 is operated by users of the network environment. In some embodiments, the processing devices are operated by a third party (e.g., a cloud-computing provider).

Testing sandbox environment 2 may include any number of FHIR sandbox UI devices 20. Similarly, the testing sandbox environment 2 may include any number of the SoF App 4, the FHIR server 6, the processing devices, and/or the databases 14. It will further be appreciated that additional systems, servers, storage mechanism, etc. may be included within the testing sandbox environment 2. In addition, although embodiments are illustrated herein having individual, discrete systems, it will be appreciated that, in some embodiments, one or more systems may be combined into a single logical and/or physical system. For example, in various embodiments, one or more of the SoF App 4, the FHIR server 6, the dynamic database 14, and/or the user computing devices may be combined into a single logical and/or physical system. Similarly, although embodiments are illustrated having a single instance of each device or system, it will be appreciated that additional instances of a device may be implemented within the testing sandbox environment 2. In some embodiments, two or more systems may be operated on shared hardware in which each system operates as a separate, discrete system utilizing the shared hardware, for example, according to one or more virtualization schemes.

The communication network 22 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 22 may provide access to, for example, the Internet.

Each of the FHIR sandbox UI devices 20 may communicate with the FHIR server 6 over the communication network 22. For example, each of the FHIR sandbox UI devices 20 may be operable to view, access, and interact with a website, such as an e-commerce website, hosted by the FHIR server 6. The FHIR server 6 may transmit user session data related to a user's activity (e.g., interactions) on the website. For example, a user may operate FHIR sandbox UI device 20 to initiate a web browser that is directed to the website hosted by the FHIR server 6. The user may, via the web browser, perform various operations such as searching one or more databases or catalogs associated with the displayed website, view data for elements associated with and displayed on the website, and click on interface elements presented via the website. The website may capture these activities as user session data, and transmit the user session data to the SoF App 4 over the communication network 22. The website may also allow the user to interact with one or more of interface elements to perform specific operations, such as selecting one or more elements for further processing. In some embodiments, the FHIR server 6 transmits user interaction data identifying interactions between the user and the website to the SoF App 4.

In some implementations, SoF App 4 is a health information platform that provides clinicians, staff, patients, and other individuals with knowledge and person-specific information to help health and health care. SoF App may encompass a variety of tools to enhance decision-making in the clinical workflow, which may include computerized alerts and reminders to care providers and patients, clinical guidelines, condition-specific order sets, focused patient data reports and summaries, documentation templates, diagnostic support, and contextually relevant reference information, among other tools.

The sandbox environment 2 may also integrate with an interface standard for health applications, such as a Substitutable Medical Applications and Reusable Technologies (“SMART”) on Fast Healthcare Interoperability Resource (“FHIR”) framework. The SMART on FHIR framework may be used to integrate with Electronic Health Records (EHRs), mimicking the sequence of clinician identity, patient ID, and encounter ID for realistic testing. These functions may be implemented by FHIR server 6.

Backend service 8 may be an ECS docker service hosted on Amazon web services. A backend service may be beneficial for load management and scalability, as a testing sandbox may test numerous instantiations of applications simultaneously, to test a wide variation of clinical scenarios.

Identity management service 12 may in some embodiments, be Microsoft Entra ID. One function of Identity management service 12 may be to accurately replicate authentication and authorization, linking user identities to a SMART on FHIR framework.

Dynamic Database 14 may in some embodiments be implemented with Amazon DynamoDB, which is a fully managed proprietary NoSQL database. Dynamic databases such as DynamoDB offer a fast persistent key-value datastore with built-in support for replication, autoscaling, encryption at rest, and on-demand backup among other features.

The SMART on FHIR framework may be used to bridge the sandbox with real or realistic scenarios, by passing authentication and authorization information for testing. Authentication and authorization information may include identifiers for clinician, patient, encounter, etc. The sandbox provides the interface and backend support for application testing.

Advantages of integrating with identity management service 8 may include improving the secure and efficient management of user authentication for SMART on FHIR applications. Integrating with identity management service 8 simplifies the login process by allowing the reuse of existing corporate credentials. The reuse of corporate credentials reduces or eliminates the need to maintain separate user databases in a testing environment, which reduces administrative overhead and potential security risks. Leveraging login flow and graph APIs, e.g. of existing solutions for identity management service 8, to validate access tokens for users and applications, ensures a streamlined and secure authentication process.

The SoF App 4 is further operable to communicate with the dynamic database 14 over the communication network 22. For example, the SoF App 4 may store data to, and read data from, the dynamic database 14. The dynamic database 14 may be a remote storage device, such as a cloud-based server, a disk (e.g., a hard disk), a memory device on another application server, a networked computer, or any other suitable remote storage. Although shown remote to the SoF App 4, in some embodiments, the dynamic database 14 may be a local storage device, such as a hard drive, a non-volatile memory, or a USB stick. The SoF App 4 may store interaction data received from the FHIR server 6 in the dynamic database 14. The SoF App 4 may also receive from the FHIR server 6 user session data identifying events associated with browsing sessions, and may store the user session data in the dynamic database 14. Dynamic database 14 may include dynamic database functionality, as discussed below.

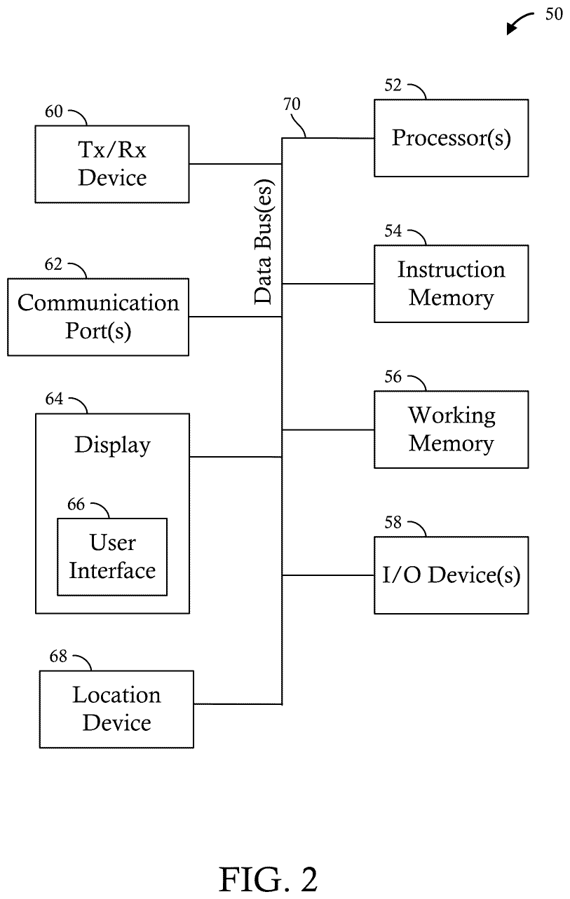

FIG. 2 illustrates a block diagram of a computing device 50, in accordance with some embodiments. In some embodiments, each of the SoF App 4, the FHIR server 6, the one or more processing devices, the workstation(s) 12, and/or the FHIR sandbox UI device 20 in FIG. 1 may include the features shown in FIG. 2. Although FIG. 2 is described with respect to certain components shown therein, it will be appreciated that the elements of the computing device 50 may be combined, omitted, and/or replicated. In addition, it will be appreciated that additional elements other than those illustrated in FIG. 2 may be added to the computing device.

As shown in FIG. 2, the computing device 50 may include one or more processors 52, an instruction memory 54, a working memory 56, one or more input/output devices 58, a transceiver 60, one or more communication ports 62, a display 64 with a user interface 66, and an optional location device 68, all operatively coupled to one or more data buses 70. The data buses 70 allow for communication among the various components. The data buses 70 may include wired, or wireless, communication channels.

The one or more processors 52 may include any processing circuitry operable to control operations of the computing device 50. In some embodiments, the one or more processors 52 include one or more distinct processors, each having one or more cores (e.g., processing circuits). Each of the distinct processors may have the same or different structure. The one or more processors 52 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 52 may also be implemented by a controller, a microcontroller, an application specific integrated circuit (ASIC), a field programmable gate array (FPGA), a programmable logic device (PLD), etc.

In some embodiments, the one or more processors 52 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 54 may store instructions that are accessed (e.g., read) and executed by at least one of the one or more processors 52. For example, the instruction memory 54 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 52 may be configured to perform a certain function or operation by executing code, stored on the instruction memory 54, embodying the function or operation. For example, the one or more processors 52 may be configured to execute code stored in the instruction memory 54 to perform one or more of any function, method, or operation disclosed herein.

Additionally, the one or more processors 52 may store data to, and read data from, the working memory 56. For example, the one or more processors 52 may store a working set of instructions to the working memory 56, such as instructions loaded from the instruction memory 54. The one or more processors 52 may also use the working memory 56 to store dynamic data created during one or more operations. The working memory 56 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 54 and working memory 56, it will be appreciated that the computing device 50 may include a single memory unit configured to operate as both instruction memory and working memory. Further, although embodiments are discussed herein including non-volatile memory, it will be appreciated that computing device 50 may include volatile memory components in addition to at least one non-volatile memory component.

In some embodiments, the instruction memory 54 and/or the working memory 56 includes an instruction set, in the form of a file for executing various methods, such as methods for an application testing sandbox environment, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, . NET, HTML, CSS, SQL, NoSQL, Rust, Perl, etc. In some embodiments a compiler or interpreter is configured to convert the instruction set into machine executable code for execution by the one or more processors 52.

The input-output devices 58 may include any suitable device that allows for data input or output. For example, the input-output devices 58 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 60 and/or the communication port(s) 62 allow for communication with a network, such as the communication network 22 of FIG. 1. For example, if the communication network 22 of FIG. 1 is a cellular network, the transceiver 60 is configured to allow communications with the cellular network. In some embodiments, the transceiver 60 is selected based on the type of the communication network 22 the computing device 50 will be operating in. The one or more processors 52 are operable to receive data from, or send data to, a network, such as the communication network 22 of FIG. 1, via the transceiver 60.

The communication port(s) 62 may include any suitable hardware, software, and/or combination of hardware and software that is capable of coupling the computing device 50 to one or more networks and/or additional devices. The communication port(s) 62 may be arranged to operate with any suitable technique for controlling information signals using a desired set of communications protocols, services, or operating procedures. The communication port(s) 62 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 62 allows for the programming of executable instructions in the instruction memory 54. In some embodiments, the communication port(s) 62 allow for the transfer (e.g., uploading or downloading) of data, such as machine learning model training data.

In some embodiments, the communication port(s) 62 are configured to couple the computing device 50 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 60 and/or the communication port(s) 62 are configured to utilize one or more communication protocols. Examples of wired protocols may include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 64 may be any suitable display and may display the user interface 66. The user interfaces 66 may enable user interaction with an application testing sandbox environment. For example, the user interface 66 may be a user interface for an application of a network environment operator that allows a user to view and interact with the operator's website. In some embodiments, a user may interact with the user interface 66 by engaging the input-output devices 58. In some embodiments, the display 64 may be a touchscreen, where the user interface 66 is displayed on the touchscreen.

The display 64 may include a screen such as, for example, a Liquid Crystal Display (LCD) screen, a light-emitting diode (LED) screen, an organic LED (OLED) screen, a movable display, a projection, etc. In some embodiments, the display 64 may include a coder/decoder, also known as Codecs, to convert digital media data into analog signals. For example, the visual peripheral output device may include video Codecs, audio Codecs, or any other suitable type of Codec.

The optional location device 68 may be communicatively coupled to a location network and operable to receive position data from the location network. For example, in some embodiments, the location device 68 includes a GPS device configured to receive position data identifying a latitude and longitude from one or more satellites of a GPS constellation. As another example, in some embodiments, the location device 68 is a cellular device configured to receive location data from one or more localized cellular towers. Based on the position data, the computing device 50 may determine a local geographical area (e.g., town, city, state, etc.) of its position.

In some embodiments, the computing device 50 is configured to implement one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations and should generally not be limited to any particular implementation exemplified herein, unless such limitations are expressly called out. In addition, a module/engine may itself be composed of more than one sub-module or sub-engine, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

To address the issue of testing clinical software applications that require user authentication and access to confidential information, e.g. about non-users, by authenticated users, an innovative internal testing sandbox that closely mimics clinical scenarios is herein disclosed. The use of such a testing sandbox allows testers to simulate clinician roles and launch applications with various patients under different scenarios, effectively testing in a realistic yet controlled environment. A key innovation is integrating an identity management service to emulate real world authentication and authorization, providing a seamless simulation of clinical workflows.

As will be described below in further detail, the solution includes an internal testing sandbox environment that provides a controlled space to test applications across different phases. The testing sandbox environment includes functional testing, which ensures features work as intended. The testing sandbox environment includes performance testing, which assesses performance under different loads. The testing sandbox environment may also include clinical testing to validate behavior according to clinical guidelines. The testing sandbox may also include automated daily testing, which improves stability.

By using authentication that mimics real clinical scenarios, the testing sandbox environment simulates various real-life scenarios, which is crucial for understanding application behavior in real workflows. Role-based simulation of clinician actions allows users to simulate clinicians launching the application with different patient profiles and scenarios (e.g., diabetes management, heart disease monitoring, etc.).

By integrating with an identity management service, such as Microsoft Entra ID, the testing sandbox environment leverages the identity management service to replicate real clinical authentication processes. For example, when a clinician launches the application, the testing sandbox environment provides parameters such as clinician identity (user ID), patient ID, and encounter ID. The testing sandbox environment may also store clinical data (e.g., patient ID, encounter ID) in a database for later use.

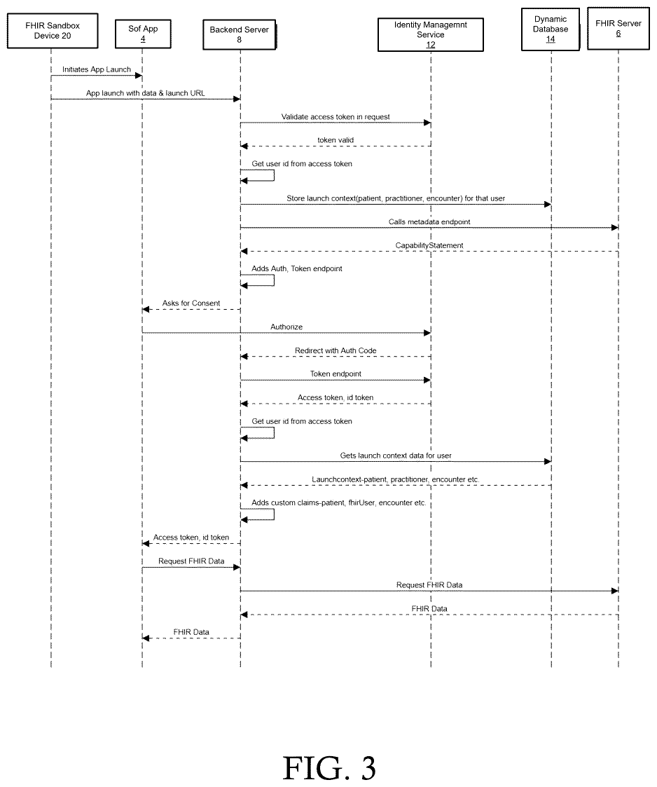

Turning now to FIG. 3, a data flow diagram of an internal testing sandbox system 300, in accordance with the present disclosure, is shown. The elements of the system 300 include a SMART on FHIR application (“SoF App”). 4, a backend service 8, an identity management service 12, a dynamic database 14, and a FHIR server 6.

To begin the testing process, a software application may be launched at a FHIR Sandbox UI device, such as FHIR Sandbox UI device 20 of FIG. 1. In some embodiments, the FHIR Sandbox UI may be a simulated FHIR Sandbox UI, such as a virtual device, for use in a testing environment. The application, at the FHIR Sandbox UI, may transmit application data and a launch application URL from the FHIR Sandbox UI to SoF App 4. Launch context data may also be transmitted from the FHIR Sandbox UI to the backend service 4. Launch context data may include user identifying data.

In some embodiments, the use case for the application is that a clinician, or a user representing a clinician, such as a person in the clinician's office, is retrieving information relating to a patient of the clinician, e.g. from the patient's electronic medical record. The retrieved information, to be used by the application, may include information relating to an encounter of the patient, either with the clinician or with other clinicians or health care providers. Launch context data may include data identifying the clinician/user, the patient, and/or the encounter. Such data may be used by the application. To work correctly, the application may need to know who the practitioner is, who is the patient and what is the encounter. This may allow the application to provide specific recommendations based on such data.

In response to receiving the launch context data, a request to validate an access token is then transmitted from backend service 8 to identity management service 12. The access token is a token that shows that the user is authorized to have access to the information required by software application, when the user of the application is the user identified in the user identifying data. At identity management service 8, the validity of the access token is determined. Identity management service 8 may include a directory or other database of users, and each user may have authorization to view the medical records of one or more patients. Each user's level of authorization, e.g. as to a given patient or encounter, may be stored in the directory at identity management service 8.

Upon a determination that the access token is valid, confirmation that the access token is valid may then be sent from identity management service 8 back to the backend service 4. Backend service 4 may then retrieve a user identifier from the access token. The user identifier may then be stored at the backend service 4 or elsewhere.

The launch context data may then be transmitted from the backend service to dynamic database 14, where it may be stored for use later in the process 300.

A command may then be transmitted from backend service 8 to a FHIR server 6. The command may instruct FHIR server 6 to call a metadata endpoint. Calling the metadata endpoint may cause a capability statement, e.g. an object, such as a JSON, containing a capability statement, to be transmitted from the FHIR server 6 to the backend service 8. In the context of FHIR (Fast Healthcare Interoperability Resources), a Capability Statement may refer to a key element that describes the functionalities and capabilities of a FHIR server or client. It may serve as a declaration of the server's compliance with FHIR specifications, outlining what the server can do and how it interacts with FHIR resources. A Capability Statement may include any or all of the following:

Supported FHIR versions: The specific FHIR version(s) the server implements.

Available operations: What kind of operations the server supports (e.g., reading, writing, searching, updating resources).

Interactions: How the server handles various FHIR interactions, such as creating or deleting resources.

Security protocols: How security is handled, including authentication, authorization, and encryption methods.

Supported resources: A list of the FHIR resources that the server can handle (e.g., Patient, Observation, Medication).

Search parameters: The parameters that can be used to search for specific resources.

Extensions: Any custom behaviors or extensions that go beyond the standard FHIR framework.

The Capability Statement may allow developers and systems to understand how to interact with a FHIR server, ensuring that different systems can work together in a computing environment.

At the backend service 8, an authorization token endpoint may then be added to the capability statement, to allow authorization, e.g. via a redirect interface, to be stored in the capability statement at backend service 8. The authorization token endpoint being in the capability statement allows it to be used for redirected authentication so that a user only has to use a single sign on to interact with SoF App 4 and also with FHIR Server 6. The capability statement, containing the authorization token, may then be transmitted from the backend service 8 back to the SoF App 4 for use with communicating with the FHIR Server 6.

An authorization message may then be transmitted from SoF App 4 to identity management service 14. The authorization message may have been created or obtained using the authorization token received as part of the capability statement.

In response to receiving the authorization message, an authorization code may then be transmitted from the identity management service 14 to the SoF App 4.

Token endpoint data may then be transmitted from the SoF App 4 to the backend service 8. The token endpoint data may then also be transmitted from the backend service 8 to the identity management service 14. The token endpoint is the location where the authorization code is obtained, which was received in the first request. At this point in the process, it is informed that the user has provided approval, and requests an access token. An access token may in some embodiments be implemented as a JSON web token. So when FHIR server 6 provides the token, the JSON token JWT token can be used to obtain the user identifier, such as e-mail address.

Backend service 8 may then request the launch context data from the dynamic database 14 and then may receive the launch context data pursuant to the request. Launch context data may include a clinician identifier, a patient identifier, and/or an encounter identifier. Launch context data may be used for application testing, wherein the application may be tested as if a clinician were accessing, and performing application functions, relating to the identified patient and/or encounter.

In some embodiments, backend service 4 may add custom claims to the launch context data. Custom claims may allow further robust application testing, such as testing involving, e.g., insurance claim information relating to the patient and/or encounter identified in the launch context data.

The access token may then be sent from the backend service 8 to the SoF App 4, to inform SoF App 4 that access has been granted. Now that it is aware of granted access, SoF App 4 may send a request for FHIR data to the backend service 8, which may forward that request to FHIR server 6. FHIR server 6 may have the full health care information needed to test the application, as requested, and for which access has been granted, via the access token, authorization code, enhanced capability statement, etc. as described above.

The FHIR data may then be received at the backend service 8 and then forwarded to the SoF App 4, where it will be used in application testing.

The system and method of the present disclosure offer significant advantages over current practices by providing a dedicated environment for launching and testing SMART on FHIR applications. A specialized sandbox, such as the present disclosure, allows developers to simulate real-world scenarios, which increases the likelihood that their applications are fully functional and compliant with operational standards, e.g. FHIR standards, before deployment. By offering a controlled and flexible testing space, the sandbox of the present disclosure enhances the development process, reduces potential errors, and accelerates the time-to-market for new healthcare applications.

Although the subject matter has been described in terms of exemplary embodiments, it is not limited thereto. Rather, the appended claims should be construed broadly, to include other variants and embodiments, which may be made by those skilled in the art.

What is claimed is:

1. A system for testing a software application for health care that requires fast healthcare interoperability resource (“FHIR”) data, comprising:
a non-transitory memory;
a processor communicatively coupled to the non-transitory memory, wherein the processor is configured to read a set of instructions to:
in a testing environment, launch the software application at a FHIR Sandbox user interface (“UI”);
transmit application data and a launch URL from the FHIR Sandbox UI to SMART on FHIR application (“SoF App”);
transmit launch context data from the FHIR Sandbox UI to a backend service, where the launch context data includes user identifying data;
in response to receiving the launch context data, transmit a request to validate an access token from the backend service to an identity management service, the access token relating to access to the software application by the user identified in the user identifying data;
at the identity management service, determine whether the access token is valid;
upon a determination that the access token is valid, send confirmation that the access token is valid, from the identity management service to the backend service;
retrieve a user identifier from the access token;
transmit the launch context data from the backend service to a dynamic database;
transmit a command from the backend service to a FHIR server, to call a metadata endpoint, causing a capability statement object to be transmitted from the FHIR server to the backend service;
at the backend service, add an authorization token to the capability statement;
transmit the capability statement, containing the authorization token, from the backend service to the SoF App;
request user consent via the FHIR Sandbox UI;
using the authorization token received as part of the capability statement, transmit an authorization message from the SoF App to the identity management service;
in response to receiving the authorization message, transmit an authorization code from the identity management service to the backend service;
transmit the token endpoint data from the backend service to the identity management service;
transmit the access token and an identification token from the identity management service to the backend service;
retrieve the user identifier from the access token;
request the launch context data from the dynamic database;
receive the launch context data at the backend service;
add custom claims to the launch context data;
send the access token from the backend service to the SoF App;
transmit a request for the FHIR data from the SoF App to the backend service;
transmit the request for FHIR data from the backend service to the FHIR server;
receive the FHIR data at the backend service;
forward the FHIR data from the backend service to the SoF App; and
use the FHIR data in the software application in the testing environment.

2. The system of claim 1, wherein the launch context data includes at least one of a patient identifier, a practitioner identifier and an encounter identifier.

3. The system of claim 2, wherein the user identifier identifies a practitioner user of the software application.

4. The system of claim 3, wherein the patient identifier and the encounter identifier relate to an encounter between the practitioner user and a patient, and wherein the FHIR data include confidential health information relating to the patient.

5. A computer-implemented method, comprising:
in a testing environment, launch the software application at a FHIR Sandbox user interface (“UI”);
transmitting application data and a launch URL from the FHIR Sandbox UI to SMART on FHIR application (“SoF App”);
transmitting launch context data from the FHIR Sandbox UI to a backend service, where the launch context data includes user identifying data;
in response to receiving the launch context data, transmitting a request to validate an access token from the backend service to an identity management service, the access token relating to access to the software application by the user identified in the user identifying data;
at the identity management service, determining whether the access token is valid;
upon a determination that the access token is valid, sending confirmation that the access token is valid, from the identity management service to the backend service;
retrieving a user identifier from the access token;
transmitting the launch context data from the backend service to a dynamic database;
transmitting a command from the backend service to a FHIR server, to call a metadata endpoint, causing a capability statement object to be transmitted from the FHIR server to the backend service;
at the backend service, adding an authorization token to the capability statement;
transmit the capability statement, containing the authorization token, from the backend service to the SoF App;
requesting user consent via the FHIR Sandbox UI;
using the authorization token received as part of the capability statement, transmitting an authorization message from the SoF App to the identity management service;
in response to receiving the authorization message, transmitting an authorization code from the identity management service to the backend service;
transmitting the token endpoint data from the backend service to the identity management service;
transmitting the access token and an identification token from the identity management service to the backend service;
retrieving the user identifier from the access token;
requesting the launch context data from the dynamic database;
receiving the launch context data at the backend service;
adding custom claims to the launch context data;
sending the access token from the backend service to the SoF App;
transmitting a request for the FHIR data from the SoF App to the backend service;
transmitting the request for FHIR data from the backend service to the FHIR server;
receiving the FHIR data at the backend service;
forwarding the FHIR data from the backend service to the SoF App; and
using the FHIR data in the software application in the testing environment.

6. The method of claim 5, wherein the launch context data includes at least one of a patient identifier, a practitioner identifier and an encounter identifier.

7. The method of claim 6, wherein the user identifier identifies a practitioner user of the software application.

8. The method of claim 7, wherein the patient identifier and the encounter identifier relate to an encounter between the practitioner user and a patient, and wherein the FHIR data include confidential health information relating to the patient.

9. A non-transitory computer readable medium having instructions stored thereon, wherein the instructions, when executed by at least one processor, cause at least one device to perform operations comprising:
in a testing environment, launch the software application at a FHIR Sandbox user interface (“UI”);
transmitting application data and a launch URL from the FHIR Sandbox UI to SMART on FHIR application (“SoF App”);
transmitting launch context data from the FHIR Sandbox UI to a backend service, where the launch context data includes user identifying data;
in response to receiving the launch context data, transmitting a request to validate an access token from the backend service to an identity management service, the access token relating to access to the software application by the user identified in the user identifying data;
at the identity management service, determining whether the access token is valid;
upon a determination that the access token is valid, sending confirmation that the access token is valid, from the identity management service to the backend service;
retrieving a user identifier from the access token;
transmitting the launch context data from the backend service to a dynamic database;
transmitting a command from the backend service to a FHIR server, to call a metadata endpoint, causing a capability statement object to be transmitted from the FHIR server to the backend service;
at the backend service, adding an authorization token to the capability statement;
transmit the capability statement, containing the authorization token, from the backend service to the SoF App;
requesting user consent via the FHIR Sandbox UI;
using the authorization token received as part of the capability statement, transmitting an authorization message from the SoF App to the identity management service;
in response to receiving the authorization message, transmitting an authorization code from the identity management service to the backend service;
transmitting the token endpoint data from the backend service to the identity management service;
transmitting the access token and an identification token from the identity management service to the backend service;
retrieving the user identifier from the access token;
requesting the launch context data from the dynamic database;
receiving the launch context data at the backend service;
adding custom claims to the launch context data;
sending the access token from the backend service to the SoF App;
transmitting a request for the FHIR data from the SoF App to the backend service;
transmitting the request for FHIR data from the backend service to the FHIR server;
receiving the FHIR data at the backend service;
forwarding the FHIR data from the backend service to the SoF App; and
using the FHIR data in the software application in the testing environment.

10. The medium of claim 9, wherein the launch context data includes at least one of a patient identifier, a practitioner identifier and an encounter identifier.

11. The medium of claim 10, wherein the user identifier identifies a practitioner user of the software application.

12. The medium of claim 11, wherein the patient identifier and the encounter identifier relate to an encounter between the practitioner user and a patient, and wherein the FHIR data include confidential health information relating to the patient.
